(19) United States
(12) Patent Application Publication
(10) Pub. No.: US 2008/0267297 A1
(43) Pub. Date: Oct. 30, 2008

(54) DE-BLOCKING FILTER ARRANGEMENTS

(75) Inventors: Jesus Sampedro, Andover, MA (US); Athar Shah, Austin, TX (US); Stephen Botzko, Reading, MA (US)

Correspondence Address: WONG, CABELLO, LUTSCH, RUTHERFORD & BRUCCULERI,;L.L.P., 20333 SH 249, SUITE 600, HOUSTON, TX, 77070, US

(73) Assignee: POLYCOM, INC., PLEASANTON, CA (US)

(21) Appl. No.: 12/109,695

(22) Filed: Apr. 25, 2008

Related U.S. Application Data
(60) Provisional application No. 60/914,277, filed on Apr. 26, 2007.

(51) Int. Cl. H04N 11/02

(52) U.S. Cl. 375/240.24; 375/E07.076

(57) ABSTRACT

Described herein is a de-blocking filter arrangement for video encoders and decoders that include a de-blocking loop filter. In some embodiments, the post filter may be configured to process all edges that were not processed by the loop filter. In other embodiments the encoder may specify which edges should be processed by the loop filter and/or by the post filter. Also disclosed herein is a de-blocking filter arrangement for video encoders and decoders that include first and second de-blocking loop filters. The second loop filter is configured to operate only on slice boundaries that were not processed by the first loop filter, e.g., for one of the reasons described above.

### CROSS-REFERENCE TO RELATED APPLICATIONS

This application claims priority to U.S. Provisional Patent Application 60/914,277, filed Apr. 26, 2007, which is hereby incorporated by reference in its entirety.

### BACKGROUND

The present application relates to video encoding and decoding, particularly as relates to videoconferencing applications. More particularly, the present application relates to various implementations of de-blocking filters and applications of multiple de-blocking filters to video image sequences. The video image sequences may be encoded by a variety of coding standards, though the techniques mentioned herein may be beneficially applied specifically with respect to ITU-T Recommendation H.264 a/k/a ISO/IEC 14496-10 (“H.264”), which is hereby incorporated by reference in its entirety. The present disclosure is also related to “De-blocking Filter Process for SVC to Support Multi-Threading with Slice Boundary De-blocking (Rev. 1),” JVT-W063, authored by Danny Hong, Alex Eleftheriadis, Ofer Shapiro, and Jesus Sampedro, submitted Apr. 26, 2007, which was attached to the provisional application referenced above and is hereby incorporated by reference in its entirety.

De-blocking filters are commonly used with various block-based video encoding algorithms to reduce or eliminate the perceptible boundaries between blocks that result from encoding such algorithms. In general, de-blocking filters can be one of two types: loop filters or post filters. Loop filters are part of the encoding and/or decoding path such that the effects of the filter are included in the reference frames that are used to reconstruct predicted blocks, i.e., inter coded blocks, or bi-directionally predicted blocks. Conversely, post filters are applied to the output of the coding loop so that their effects are not included in the reference frames.

In some embodiments, it has been found to be advantageous to implement an H.264 encoder and/or decoder using multi-threaded, multi-processor, and/or multi-core processor implementations. In these implementations, a certain portion of an image, e.g., a slice, may be encoded by one thread, processor, and/or core, while another portion of the same image, e.g., another slice, may be encoded by a different thread, processor, and/or core. Such embodiments may not use the de-blocking loop filter specified by the standard across the sections (e.g., slices) coded by different threads, chips, and/or cores. For example, this filter is often disabled across boundaries between slices encoded by different threads, processors, and/or cores for system performance reasons. Because of this, the H.264 standard permits the use (or non-use) of the de-blocking loop filter to be signaled in the H.264 bitstream.

In addition to the multi-thread, processor, and/or core embodiments, other situations exist in which it is desired to disable a de-blocking loop filter across a slice boundary. For example, a low-complexity continuous presence (H.264 soft-CP) can be implemented in H.264 using flexible macroblock ordering (“FMO”) to manipulate the received bitstream from different endpoints to build a new bitstream with a composed continuous presence frame. In soft-CP, the de-blocking loop-filter is disabled across all slice edges. This can result in blockiness of the individual sections of the continuous presence image. For instance, in a 4-quadrant continuous presence embodiment, a sectioning effect can frequently be seen across the internal slice edges within each quadrant. However, it may not be seen across the edges between participants.

In any case, disabling the de-blocking loop filter is usually disadvantagous to image quality because of the visual sectioning effect when the video is displayed. Therefore, what is needed in the art is a video encoding/decoding arrangement in which de-blocking filtering may be added back into these and various other embodiments in which the de-blocking filters may be disabled.

### SUMMARY

Described herein is a de-blocking filter arrangement for video encoders and decoders that include a de-blocking loop filter. In some embodiments, the post filter may be configured to process all edges that were not processed by the loop filter. In other embodiments the encoder may specify which edges should be processed by the loop filter and/or by the post filter.

Also disclosed herein is a de-blocking filter arrangement for video encoders and decoders that include first and second de-blocking loop filters. The second loop filter can be configured to operate only on slice boundaries that were not processed by the first loop filter, e.g., for one of the reasons described above. Alternatively, the first and second loop filters may be configured independently to process or not process certain edges and/or luma and/or chroma data.

### BRIEF DESCRIPTION OF THE DRAWINGS

FIG. 1 illustrates a simplified block diagram of a video decoding loop with a de-blocking loop filter and a de-blocking post filter.

FIG. 2 illustrates a simplified block diagram of a video decoding loop with two de-blocking loop filters.

### DETAILED DESCRIPTION

Throughout this description, video encoding and decoding will be defined in terms of various components of video, including pictures, frames, fields, blocks, slices, macroblocks, etc. It will be well understood by those skilled in the art that in many cases a description of operations on a frame may also apply to the fields of interlaced video, that the terms “blocks” and “macroblocks” may be synonomous or not depending on the context, etc. Therefore, the following description is intended to be read and understood from the perspective of one ordinarily skilled in the art of video compression and encoding.

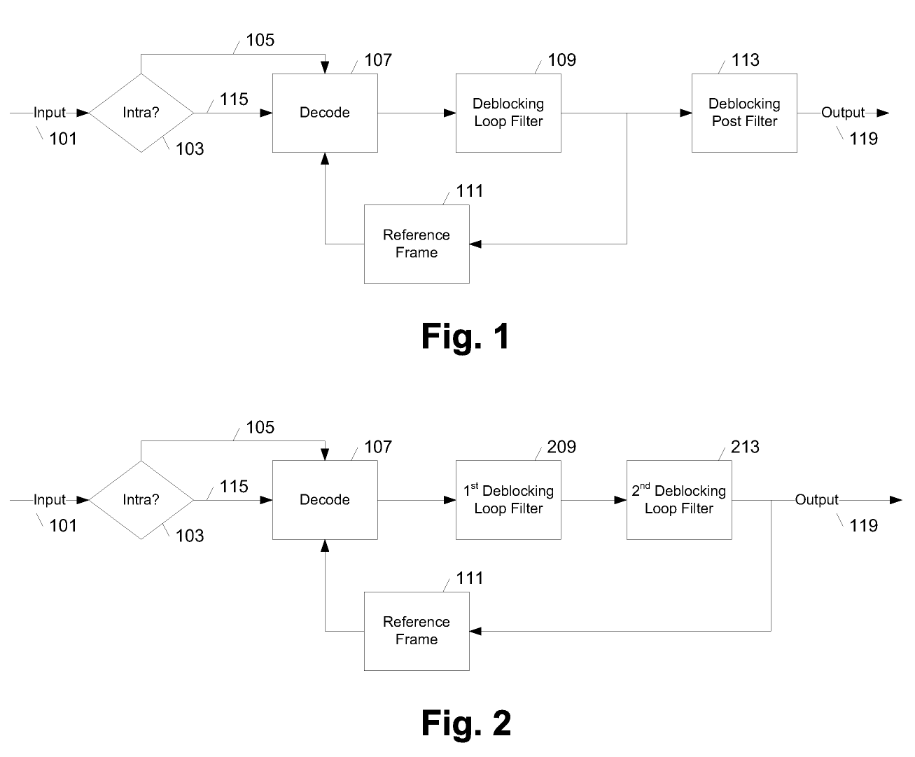

FIG. 1 illustrates a simplified diagram of an exemplary video decoding loop. Input video data 101 is analyzed in switch 103 to determine whether it contains intra-coded frame (or field) data, i.e., video pictures coded solely with reference to themselves or predicted frame (or field) data (e.g., either inter or bi-directionally predicted pictures), which are coded with reference to another picture (i.e., a “reference frame”). If the frame is intra coded, it follows path 105 to decoder 107, which decodes the intra frame in accordance with some encoding/decoding algorithm. The decoded frame may then be passed through an optional de-blocking loop filter 109 and/or an optional de-blocking post filter 113 to become output frame data 119, which may be, for example, displayed for a user. Additionally, the decoded frame (after the loop-filter, if loop filtering is in use) is stored as reference frame 111, which is used with predicted frames as follows. If the input data 101 is determined (by switch 103) to contain predictive frame data, it follows path 115 to decoder 107, which combines the input data (i.e., prediction information) with reference frame 111 according to some encoding/decoding algorithm to produce a decoded frame. As with the intra-coded frame discussed above, the decoded predicted frame may be subjected to a loop de-blocking filter 109 and/or a de-blocking post filter 113 to produce output frame 119. Also, this decoded frame may update the reference frame 111.

As noted above, the H.264 video encoding algorithm includes a de-blocking loop filter, although the use of this de-blocking loop filter may be selectively turned off. In some embodiments, it may be desirable to add a de-blocking post-filter after the H.264 decoder to complement, supplement, and/or replace the de-blocking loop filter. In one mode of operation, the de-blocking post-filter can process all edges in the decoded frame that were not subjected to the de-blocking loop filter. In another mode of operation, the encoder may specify which edges should use the de-blocking post-filter by adding a hint or trigger to the video bitstream. These hints can include the use of flags or other signals, or can be predetermined portions of a video bitstream, such as a slice boundary. This provides the ability for the encoder to have complete control over the de-blocking applied by the decoder, which may advantageously be used to specify that a particular edge should not be de-blocked.

Either of these operational modes can be used with not just H.264, but with other algorithms that may or may not include de-blocking loop filters. In any event, the combination of a de-blocking post-filter and a de-blocking loop filter can substantially reduce the sectioning effect on decoded images, which can substantially improve the picture quality. Additionally, use of the de-blocking post filter can be useful to enhance image quality in cases where the de-blocking loop-filter can not be used (e.g., soft-CP) or where the use of the de-blocking loop filter is impractical because of substantial performance limitation (e.g., a multi-processor implementation).

In an alternative embodiment, rather than a de-blocking post filter, a second in-loop de-blocking filter may be added that processes only the slice edges that were not de-blocked by the first in-loop de-blocking filter (e.g., one which was disabled across slice boundaries). A simplified block diagram is illustrated in FIG. 2, in which like-numbered items are similar to the corresponding items in FIG. 1. In the decoder of FIG. 2, the first de-blocking loop filter 209 may operate certain edges while excluding others. For example, the first de-blocking loop filter 209 may process all edges other than those at slice boundaries. Second de-blocking loop filter 213 may then process the edges corresponding to slice boundaries. This can, for example, be used to maximize the number of macroblock edges that can be processed independently (e.g., those other than slice boundaries), which in the case of implementation with multiple threads, multiple cores or multiple processors, may result in substantial computational efficiencies. This approach also minimizes the number of macroblock edges that need to be processed by the second in-loop de-blocking filter.

In another variation, the encoder could specify, through the use of flags or other triggers in the bitstream that certain edges were to be processed by the first de-blocking loop filter 209, the second de-blocking loop filter 213, both de-blocking loop filters, or neither de-blocking loop filter. Additionally, each of the de-blocking loop filters may independently operate on luma and chroma blocks, luma blocks only, or chroma blocks only. For example, it may be desirable in some embodiments to have the first de-blocking loop filter process luma and chroma blocks, while the second de-blocking loop filter processes only luma blocks.

Yet another variation is possible in which the decoding loop includes a single in-loop de-blocking filter through which two (or more) passes are made. For example, in a first pass, slice edges are not de-blocked, and in the second pass the slice edges are de-blocked. Other uses for multiple numbers of passes are also possible and will be appreciated by those skilled in the art.

The disclosed systems and methods can be implemented in digital electronic circuitry, or in computer hardware, firmware, software, or in combinations of them. For example, software implementations can include third party add-ins, etc. and can also be implemented as hardware, firmware, etc., as mentioned above. Apparatus of the disclosure can be implemented in a computer program product tangibly embodied in a machine-readable storage device for execution by a programmable processor, and method steps of the disclosure can be performed by a programmable processor executing a program of instructions to perform functions of the method by operating on input data and generating output. The method can be implemented advantageously in one or more computer programs that are executable on a programmable system including at least one programmable processor, coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors having single or multiple cores, digital signal processors (DSPs), etc., including multiple processors and/or cores operating in parallel Generally, a processor will receive instructions and data from a read-only memory and/or a random access memory. Generally, a computer will include one or more mass storage devices for storing data files. Such devices may include magnetic disks, such as internal hard disks and removable disks, magneto-optical disks, flash memory devices, optical disks, etc. Storage devices suitable for tangibly embodying computer program instructions and data include all forms of non-volatile memory, including by way of example semiconductor memory devices, such as EPROM, EEPROM, and flash memory devices, magnetic disks such as internal hard disks and removable disks, magneto-optical disks, and CD-ROM, DVD-ROM, HD-DVD, and BlueRay discs. Any of the foregoing can be supplemented by, or incorporated in, ASICs (application-specific integrated circuits) or FPGAs (field programmable gate arrays).

A number of implementations of the disclosed methods and apparatus have been described. Nevertheless, it will be understood that various modifications may be made without departing from the spirit and scope of the invention. For example, although the embodiments described herein have been described in terms of video decoding arrangements, those skilled in the art will readily understand that the principles discussed herein may also be applied to video encoding arrangements. Accordingly, these and other embodiments fall within the scope of the appended claims.

What is claimed is:

1. A video decoding arrangement comprising:
a video decoder coupled to an input that provides an input video data bitstream;
a first de-blocking filter coupled to the output of the video decoder; and
a second de-blocking filter coupled to the output of the first de-blocking filter.

2. The video decoding arrangement of claim 1 wherein the first de-blocking filter is a loop filter and the second de-blocking filter is a post filter.

3. The video decoding arrangement of claim 2 wherein at least one of the first de-blocking filter and the second de-blocking filter is configurable to operate on all edges of the decoded video data, a subset of the edges of the decoded video data, or none of the edges of the video data.

4. The video decoding arrangement of claim 3 where at least one of the first de-blocking filter and the second de-blocking filter is pre-configured to operate on certain edges.

5. The video decoding arrangement of claim 3 wherein at least one of the first de-blocking filter and the second de-blocking filter is configured by the input video data bitstream.

6. The video decoding arrangement of claim 2 wherein the first de-blocking filter is configured to process edges other than slice boundaries and wherein the second de-blocking filter is configured to process slice boundaries.

7. The video decoding arrangement of claim 2 wherein the first de-blocking filter is configured to process luma and chroma data and wherein the second de-blocking filter is configured to process only luma data.

8. The video decoding arrangement of claim 2 wherein the second de-blocking filter is configured to process edges not processed by the first de-blocking filter.

9. The video decoding arrangement of claim 1 wherein the first de-blocking filter and the second de-blocking filter are both loop filters.

10. The video decoding arrangement of claim 9 wherein at least one of the first de-blocking filter and the second de-blocking filter is configurable to operate on all edges of the decoded video data, a subset of the edges of the decoded video data, or none of the edges of the video data.

11. The video decoding arrangement of claim 10 where at least one of the first de-blocking filter and the second de-blocking filter is pre-configured to operate on certain edges.

12. The video decoding arrangement of claim 10 wherein at least one of the first de-blocking filter and the second de-blocking filter is configured by the input video data bitstream.

13. The video decoding arrangement of claim 9 wherein the first de-blocking filter is configured to process edges other than slice boundaries and wherein the second de-blocking filter is configured to process slice boundaries.

14. The video decoding arrangement of claim 9 wherein the first de-blocking filter is configured to process luma and chroma data and wherein the second de-blocking filter is configured to process only luma data.

15. The video decoding arrangement of claim 9 wherein the second de-blocking filter is configured to process edges not processed by the first de-blocking filter.

16. A video encoding arrangement comprising:
a video encoder configured to produce an encoded video bitstream;
a first de-blocking loop filter coupled to the output of the video encoder; and
a second de-blocking loop filter coupled to the output of the first de-blocking loop filter.

17. The video encoding arrangement of claim 16 wherein at least one of the first de-blocking filter and the second de-blocking filter is configurable by the encoder to operate on all edges of the encoded video bitstream, a subset of the edges of the encoded video bitstream, or none of the edges of the encoded video bitstream.

18. The video encoding arrangement of claim 17 wherein the first de-blocking filter is configured to process edges other than slice boundaries and wherein the second de-blocking filter is configured to process slice boundaries.

19. The video encoding arrangement of claim 17 wherein the first de-blocking filter is configured to process luma and chroma data and wherein the second de-blocking filter is configured to process only luma data.

20. The video encoding arrangement of claim 17 wherein the second de-blocking filter is configured to process edges not processed by the first de-blocking filter.

21. The video encoding arrangement of claim 16 where the encoded video bitstream includes one or more indications to a decoder indicating how de-blocking filters should be applied to the encoded video bitstream by the decoder.

22. A method of decoding video data, the method comprising:
receiving an input video data bitstream;
decoding the input video data bitstream to produce decoded video;
applying a first de-blocking filter to the decoded video to produce de-blocked video; and
applying a second de-blocking filter to the de-blocked video to produce final video.

23. The method of claim 22 wherein:
applying a first de-blocking filter to the decoded video to produce de-blocked video comprises de-blocking edges other than slice boundaries; and
applying a second de-blocking filter to the de-blocked video to produce final video comprises de-blocking slice boundaries.

24. The method of claim 22 wherein:
applying a first de-blocking filter to the decoded video to produce de-blocked video comprises de-blocking edges specified in the input video data bitstream; and
applying a second de-blocking filter to the de-blocked video to produce final video comprises de-blocking other edges specified in the input video data bitstream.

25. The method of claim 24 wherein de-blocking other edges specified in the input video data bitstream comprises de-blocking edges that were not de-blocked by the first de-blocking filter.

26. The method of claim 22 wherein:
applying a first de-blocking filter to the decoded video to produce de-blocked video comprises de-blocking luma and chroma data; and
applying a first de-blocking filter to the de-blocked video to produce final video comprises de-blocking only luma data.

27. The method of claim 22 wherein applying a first de-blocking filter and applying a second de-blocking filter comprise sequential applications of a single, configurable de-blocking filter.

28. A method of encoding video data, the method comprising:
receiving input video;
encoding the input to produce encoded video;
applying a first de-blocking filter to the encoded video to produce de-blocked encoded video; and
applying a second de-blocking filter to the de-blocked encoded video to produce an encoded video data bitstream.

29. The method of claim 28 wherein:
applying a first de-blocking filter to the encoded video to produce de-blocked encoded video comprises de-blocking edges other than slice boundaries; and
applying a second de-blocking filter to the de-blocked encoded video to produce an encoded video data bitstream comprises de-blocking slice boundaries.

30. The method of claim 28 wherein:
applying a first de-blocking filter to the encoded video to produce de-blocked encoded video comprises de-blocking edges specified by the encoder; and
applying a second de-blocking filter to the de-blocked encoded video to produce an encoded video data bitstream comprises de-blocking other edges specified by the encoder.

31. The method of claim 30 wherein de-blocking other edges specified by the encoder comprises de-blocking edges that were not de-blocked by the first de-blocking filter.

32. The method of claim 28 wherein:
applying a first de-blocking filter to the encoded video to produce de-blocked encoded video comprises de-blocking luma and chroma data; and
applying a second de-blocking filter to the de-blocked encoded video to produce an encoded video data bitstream comprises de-blocking only luma data.

33. The method of claim 28 wherein applying a first de-blocking filter and applying a second de-blocking filter comprise sequential applications of a single, configurable de-blocking filter.

34. The method of claim 28 further comprising embedding within the encoded video data bitstream one or more one or more indications to a decoder indicating how de-blocking filters should be applied to the encoded video bitstream by the decoder.
